(19) United States
(12) Patent Application Publication
(10) Pub. No.: US 2017/0207427 A1
(43) Pub. Date: Jul. 20, 2017

(54) ADHESIVE FOR LAMINATING METAL FOIL TO RESIN FILM, LAMINATE OBTAINED USING SAID COMPOSITION, PACKAGING MATERIAL FOR BATTERY CASING, AND BATTERY CASE

(71) Applicant: SHOWA DENKO K.K., Tokyo (JP)

(72) Inventors: Hiroto KOUKA, Tatsuno-shi (JP); Kazunari FUKASE, Himeji-shi (JP); Naoki MURATA, Himeji-shi (JP); Hui LI, Himeji-shi (JP); Yasuhiro NAKAGAWA, Kakogawa-shi (JP); Mitsuru DOI, Tatsuno-shi (JP)

(73) Assignee: SHOWA DENKO K.K., Tokyo (JP)

(21) Appl. No.: 15/326,137

(22) PCT Filed: May 25, 2015
(86) PCT No.: PCT/JP2015/064963

§ 371 Date: Jan. 13, 2017

(30) Foreign Application Priority Data
Aug. 5, 2014 (JP) 2014-159865

(51) Int. Cl. H01M 2/02; B32B 15/20; B32B 15/08; B29C 55/00; B29C 55/02; C08G 18/73; H01M 10/0525; C08G 18/10; C08G 18/42; C09J 175/06; C08G 18/24; B29C 51/00; B29C 51/08

(52) U.S. Cl. CPC H01M 2/0287; B29C 51/002; B32B 15/20; B32B 15/08; B29C 55/005; B29C 55/023; B29C 51/08; H01M 10/0525; H01M 2/0277; C08G 18/10; C08G 18/42; C09J 175/06; C08G 18/242; C08G 18/73; B32B 2255/06; B32B 2255/26; B32B 2457/10; B32B 2250/02; B29L 2031/3468

(57) ABSTRACT

There are provided an adhesive for laminating a metal foil to a resin film and the like, the adhesive comprising: a polyurethane polyol (A); and a saturated aliphatic and/or saturated alicyclic polyisocyanate (B), wherein the polyurethane polyol (A) is obtained by polyaddition of components comprising a chain polyolefin polyol (a1) and/or a polyester polyol (a2) having a constituent unit derived from a hydrogenated dimer acid and a constituent unit derived from a hydrogenated dimer diol, a hydroxylated hydrocarbon compound (b) having a saturated or unsaturated cyclic hydrocarbon structure and two or more hydroxy groups, and a polyisocyanate (c).

### TECHNICAL FIELD

The present invention relates to an adhesive for laminating a metal foil to a resin film suitable as an adhesive for a covering material of a secondary battery such as a lithium ion battery, a laminate produced by using the adhesive for laminating a metal foil to a resin film, a packaging material for a battery casing using the laminate, and a battery case formed of the packaging material for a battery casing.

### BACKGROUND ART

In recent years, the reduction in size, weight, and thickness of electronic appliances such as notebook personal computers and mobile phones has proceeded. Therefore, high performance, reduction in weight, and improvement in portability are required also for secondary batteries for electronic appliances, and development of lithium ion batteries having high energy density has been actively made instead of conventional lead storage batteries. Further, a lithium ion battery which can be used also as a power source of an electric vehicle or a hybrid car has been put in practical use.

In the lithium ion battery, a compound containing lithium is used as a positive electrode material, and a carbon material such as graphite and coke is used as a negative electrode material. Further, between a positive electrode and a negative electrode, there is provided an electrolytic solution in which a lithium salt such as LiPF₆ and LiBF₄ as an electrolyte is dissolved in an aprotic solvent having osmotic force such as propylene carbonate and ethylene carbonate, or an electrolyte layer comprising a polymer gel impregnated with the electrolytic solution.

Conventionally, as a packaging material for a battery case, there has been known a laminate in which a stretched heat resistant resin film layer as an outer layer, an aluminum foil layer, and a non-stretched thermoplastic resin film layer as an inner layer are laminated in this order. In the case of a battery case obtained by using a packaging material for battery cases having such a structure, if a solvent having osmotic force like an electrolytic solution passes through a film layer serving as a sealant in a laminate used for the outer packaging of the battery, the laminate strength between an aluminum foil layer and a resin film layer may be reduced to cause the leakage of the electrolytic solution. Therefore, there has been developed a packaging material for battery cases in which an aluminum foil layer and an inner layer are bonded through an adhesive layer containing a resin containing a functional group having reactivity with isocyanates such as an acid anhydride group, a carboxyl group, and a hydroxy group, and a polyfunctional isocyanate compound.

For example, Patent Literature 1 describes a method involving forming an adhesive layer using a solvent type adhesive in which a modified polyolefin resin obtained by graft-polymerizing an ethylenically unsaturated carboxylic acid or an anhydride thereof onto a propylene homopolymer or a copolymer of propylene and ethylene, and a polyfunctional isocyanate compound, are dissolved or dispersed in an organic solvent.

Meanwhile, Patent Literature 2 describes an adhesive composition in which a polyolefin polyol and a polyfunctional isocyanate curing agent are used as essential components, and a thermoplastic elastomer and/or a tackifier are further added thereto; and Patent Literature 3 describes an adhesive composition containing one or more main agents selected from the group consisting of a polyester polyol having a hydrophobic unit derived from a dimer fatty acid or a hydrogenated product thereof and an isocyanate-extended product of the polyester polyol, and a curing agent comprising one or more polyisocyanate compounds selected from the group consisting of crude tolylene diisocyanate, crude diphenylmethane diisocyanate, and polymeric diphenylmethane diisocyanate.

### CITATION LIST

### Patent Literature

PTL1: JP 2010-92703 A

PTL2: JP 2005-63685 A

PTL3: JP 2011-187385 A

### SUMMARY OF INVENTION

### Technical Problem

However, the modified polyolefin resin in Patent Literature 1 shows a change with time in long-term storage and after being dissolved in a solvent. Therefore, the operability of the modified polyolefin resin may often be unstable on coating, and the adhesive strength of the adhesive layer formed may show variation. Further, an adhesive strength at high temperatures assuming an on-vehicle applications or the like may be poor.

Further, in the case of Patent Literature 2 and Patent Literature 3, the operability on coating and adhesive strength are relatively stable. However, when an adhesive layer contacts the electrolytic solution which passes through a film layer serving as a sealant in the laminate, the adhesive strength will be reduced to reduce the quality of a battery, which is problematic.

The present invention has been completed taking the background art as described above into consideration, and an object of the present invention is to provide an adhesive for laminating a laminating metal foil to a resin film, the adhesive having excellent adhesive strength and being suitable for joining aluminum foil to a heat-fusible resin film. Further, another object of the present invention is to provide a laminate of a metal foil and a resin film, the laminate being excellent in heat resistance and electrolytic solution resistance and being suitable as a packaging material for a battery casing. Furthermore, a still another object of the present invention is to provide a battery case excellent in heat resistance and electrolytic solution resistance, the battery case being formed of the packaging material for a battery casing comprising the laminate.

### Solution to Problem

Specifically, the present invention relates to the following [1]-[15].

[1] A polyurethane polyol used for a polyurethane adhesive, the polyurethane polyol being obtained by polyaddition of components comprising a chain polyolefin polyol (a1) and/or a polyester polyol (a2) having a constituent unit derived from a hydrogenated dimer acid and a constituent unit derived from a hydrogenated dimer diol, a hydroxylated hydrocarbon compound (b) having a saturated or unsaturated cyclic hydrocarbon structure and two or more hydroxy groups, and a polyisocyanate (c).
[2] An adhesive for laminating a metal foil to a resin film, the adhesive comprising: a polyurethane polyol (A); and a saturated aliphatic and/or saturated alicyclic polyisocyanate (B), wherein the polyurethane polyol (A) is obtained by polyaddition of components comprising a chain polyolefin polyol (a1) and/or a polyester polyol (a2) having a constituent unit derived from a hydrogenated dimer acid and a constituent unit derived from a hydrogenated dimer diol, a hydroxylated hydrocarbon compound (b) having a saturated or unsaturated cyclic hydrocarbon structure and two or more hydroxy groups, and a polyisocyanate (c).
[3] The adhesive for laminating a metal foil to a resin film according to [2], wherein the hydroxylated hydrocarbon compound (b) is a polyol containing a saturated alicyclic structure having a crosslinked structure.
[4] The adhesive for laminating a metal foil to a resin film according to [2] or [3], wherein the hydroxylated hydrocarbon compound (b) is a bisphenol compound.
[5] The adhesive for laminating a metal foil to a resin film according to any one of [2] to [4], wherein the polyisocyanate (c) is a saturated alicyclic diisocyanate.
[6] The adhesive for laminating a metal foil to a resin film according to any one of [2] to [5], wherein the chain polyolefin polyol (a1) is a polyolefin polyol which does not substantially contain an unsaturated hydrocarbon structure.
[7] The adhesive for laminating a metal foil to a resin film according to any one of [2] to [6], wherein the amount of the component (b) is 5 to 100 parts by mass based on 100 parts by mass of the total amount of the components (a1) and (a2); and the ratio of the number of isocyanato groups contained in the component (c) to the number of hydroxy groups contained in the components (a1), (a2), and (b) is 0.5 to 1.3.
[8] The adhesive for laminating a metal foil to a resin film according to any one of [2] to [7], wherein the ratio of the number of isocyanato groups contained in the polyisocyanate (B) to the number of hydroxy groups contained in the polyurethane polyol (A) is 1 to 15.
[9] The adhesive for laminating a metal foil to a resin film according to any one of [2] to [8], the adhesive further comprising a solvent (C).
[10] A laminate in which a metal foil and a resin film are laminated through an adhesive layer obtained from the adhesive for laminating a metal foil to a resin film according to any one of [2] to [9].
[11] The laminate according to [10], wherein the metal foil is aluminum foil, and the resin film comprises a heat-fusible resin film.
[12] The laminate according to [10] or [11], wherein the thickness of the metal foil is 10 to 100 μm, and the thickness of the resin film is 9 to 100 μm.
[13] A packaging material for a battery casing obtained by using the laminate according to any one of [10] to [12].
[14] A battery case obtained by using the packaging material for a battery casing according to [13].
[15] A method for producing a battery case, comprising: deep drawing or stretch forming the packaging material for a battery casing according to [13].

### Advantageous Effects of Invention

The adhesive for laminating a metal foil to a resin film of the present invention is excellent in adhesive strength, and a laminate of a metal foil and a resin film which is formed by using the adhesive for laminating a metal foil to a resin film is excellent in heat resistance and electrolytic solution resistance. Therefore, the laminate is suitable as a material for a packaging material for a battery casing used for preparing a secondary battery such as a lithium ion battery. Further, a battery case formed by using the packaging material for a battery casing of the present invention is excellent in heat resistance and electrolytic solution resistance, and its use can provide a safe secondary battery having a long life.

### DESCRIPTION OF EMBODIMENTS

The adhesive for laminating a metal foil to a resin film of the present invention comprises a polyurethane polyol (A) and a saturated aliphatic and/or saturated alicyclic polyisocyanate (B), wherein the polyurethane polyol (A) is obtained by polyaddition of components comprising a chain polyolefin polyol (a1) and/or a polyester polyol (a2) having a constituent unit derived from a hydrogenated dimer acid and a constituent unit derived from a hydrogenated dimer diol, a hydroxylated hydrocarbon compound (b) having a saturated or unsaturated cyclic hydrocarbon structure and two or more hydroxy groups, and a polyisocyanate (c).

In the adhesive for laminating a metal foil to a resin film of the present invention, the polyurethane polyol (A) corresponds to a main agent, and the saturated aliphatic and/or saturated alicyclic polyisocyanate (B) corresponds to a curing agent.

The adhesive for laminating a metal foil to a resin film of the present invention can be suitably used for the adhesion of a metal foil to a resin film. Particularly, it is useful as an adhesive for laminating a metal foil to a resin film, and a laminate therewith can be suitably used as a packaging material for a battery casing.

The symbol “-” used herein means a value before the “-” or more and a value after the “-” or less.

### <Polyurethane Polyol (A)>

The polyurethane polyol (A) used in the present invention is obtained by polyaddition of components comprising the component (a1) and/or the component (a2), the component (b), and the component (c) as described above.

[Chain Polyolefin Polyol (a1)]

The “chain polyolefin polyol (a1)” of the present invention means a polyolefin polyol (a1) which does not contain an alicyclic structure.

The chain polyolefin polyol (a1) (hereinafter also referred to as “polyolefin polyol (a1)”) used in the present invention is not particularly limited, as long as it contains a polyolefin skeleton prepared by polymerizing or copolymerizing one or two or more olefins and two or more hydroxy groups and does not have an alicyclic structure. Specific examples thereof include polydiene polyols such as polybutadiene polyol and polyisoprene polyol, graft polymers of polydiene polyols and polyolefins, and hydrogenated products of these polydiene polyols and graft polymers. These may be used singly or in combination of two or more. In view of the electrolytic solution resistance of the adhesive layer obtained from the adhesive for laminating a metal foil to a resin film of the present invention, chain polyolefin polyols which do not substantially contain an unsaturated hydrocarbon structure in their structures are preferred, and examples thereof include the hydrogenated products of various polydiene polyols and graft polymers described above. Examples of commercially available products thereof include GI-1000, GI-2000, GI-3000 (all manufactured by Nippon Soda Co., Ltd.) and Epaule (manufactured by Idemitsu Kosan Co., Ltd.).

The number average molecular weight of the polyolefin polyol (a1) is preferably 1000 to 10,000. When the number average molecular weight is 1000 or more, the adhesive strength of the adhesive layer obtained from the adhesive for laminating a metal foil to a resin film of the present invention will hardly be reduced even if the adhesive layer contacts an electrolytic solution; and when the number average molecular weight is 10,000 or less, the solubility of polyurethane polyol (G) to be described below in a solvent and the operability of the adhesive for laminating a metal foil to a resin film of the present invention on coating will be satisfactory.

Note that the number average molecular weight in the present invention is a value which has been measured at ordinary temperature according to the following conditions using gel permeation chromatography (Shodex GPC System-11, “Shodex” (registered trademark), manufactured by Showa Denko K.K.) and determined using a standard polystyrene calibration curve.

Column: KF-806L, manufactured by Showa Denko K.K.

Column temperature: 40° C.

Sample: 0.2% by mass solution of sample polymer in tetrahydrofuran

Flow rate: 2 ml/minute

Eluent: tetrahydrofuran

Detector: Differential refractometer (RI)

[Polyester Polyol (a2) Having Constituent Unit Derived from Hydrogenated Dimer Acid and Constituent Unit Derived from Hydrogenated Dimer Diol]

The polyester polyol (a2) having a constituent unit derived from a hydrogenated dimer acid and a constituent unit derived from a hydrogenated dimer diol (hereinafter also referred to as “polyester polyol (a2)”) used in the present invention has the constituent unit derived from a hydrogenated dimer acid and the constituent unit derived from a hydrogenated dimer diol in view of the electrolytic solution resistance of the adhesive layer obtained from the adhesive for laminating a metal foil to a resin film of the present invention.

The “dimer acid” herein refers to a dimer acid obtained by allowing fatty acids each having 14 to 22 carbon atoms and an ethylenic double bond (hereinafter also referred to as “unsaturated fatty acid A”) to react with each other at the double bond site. The dimer acid is preferably obtained by allowing an unsaturated fatty acid A having 2 to 4 ethylenic double bonds to react with an unsaturated fatty acid A having 1 to 4 ethylenic double bonds, more preferably by allowing an unsaturated fatty acid A having two ethylenic double bonds to react with an unsaturated fatty acid A having one or two ethylenic double bonds. Examples of the above unsaturated fatty acid A include tetradecenoic acid (tsuzuic acid, physeteric acid, and myristoleic acid), hexadecenoic acid (such as palmitoleic acid), octadecenoic acid (such as oleic acid, elaidic acid, and vaccenic acid), eicosenic acid (such as gadoleic acid), dococenoic acid (such as erucic acid, cetoleic acid, and brassidic acid), tetradecadienoic acid, hexadecadienoic acid, octadecadienoic acid (such as linoleic acid), eicosadienoic acid, docosadienoic acid, octadecatrienoic acid (such as linolenic acid), and eicosatetraenoic acid (such as arachidonic acid); and oleic acid or linoleic acid is most preferred. The resulting dimer acid is a mixture of dimer acids whose structures are generally different due to the position of a double bond or isomerization. The dimer acids in the mixture may be separated and used, or the mixture may be used as it is. Further, the resulting dimer acid may contain a small amount of monomer acid (for example, 6% by weight or less, particularly 4% by weight or less) and/or polymeric acid including trimer and higher acid (for example, 6% by weight or less, particularly 4% by weight or less).

The “hydrogenated dimer acid” herein refers to a saturated dicarboxylic acid obtained by hydrogenating a carbon-carbon double bond of the dimer acid. Examples of commercially available products of the hydrogenated dimer acid include EMPOL 1008 and EMPOL 1062 (both manufactured by BASF AG) and PRIPOL 1009 (manufactured by Croda, Inc.).

The “hydrogenated dimer diol” in the present invention contains a diol as a main component, and the diol is prepared as follows: at least one of the dimer acid, the hydrogenated dimer acid, and a lower alcohol ester thereof is reduced in the presence of a catalyst to convert a carboxylic acid part or a carboxylate part of the dimer acid into an alcohol and, when the raw material has a carbon-carbon double bond, the double bond is hydrogenated. Examples of commercially available products of the hydrogenated dimer diol include Sovermol 908 (manufactured by BASF AG) and PRIPOL 2033 (manufactured by Croda, Inc.).

The polyester polyol (a2) used in the present invention can be produced by the condensation reaction, in the presence of an esterification catalyst, of an acid component comprising the hydrogenated dimer acid as an essential component and an alcohol component comprising the hydrogenated dimer diol as an essential component. Alternatively, the polyester polyol (a2) used in the present invention can also be produced by the transesterification reaction, in the presence of a transesterification catalyst, of an ester component comprising the lower alkyl ester of the hydrogenated dimer acid as an essential component and an alcohol component comprising the hydrogenated dimer diol as an essential component.

### [Hydroxylated Hydrocarbon Compound (b) Having Saturated or Unsaturated Cyclic Hydrocarbon Structure and Two or More Hydroxy Groups]

The hydroxylated hydrocarbon compound (b) having a saturated or unsaturated cyclic hydrocarbon structure and two or more hydroxy groups (hereinafter also referred to as “hydroxylated cyclic hydrocarbon (b)”) used in the present invention is not particularly limited as long as it is a compound that has an unsaturated or saturated alicyclic hydrocarbon structure, two or more hydroxy groups, and a structure of other parts comprising hydrocarbon, in view of the electrolytic solution resistance of the adhesive layer obtained from the adhesive for laminating a metal foil to a resin film of the present invention.

Examples of the saturated cyclic hydrocarbon structure include cycloalkane skeletons, such as a cyclopentane skeleton, a cyclohexane skeleton, and a cycloheptane skeleton, and saturated alicyclic structures each having a crosslinked structure such as a norbornane skeleton, an adamantane skeleton, and a tricyclodecane skeleton; and examples of the hydroxylated cyclic hydrocarbons (b) each having such a structure include cyclopentanediol, cyclohexanediol, cyclohexanedimethanol, norbornanediol, adamantanediol, and tricyclodecanedimethanol. These may be used singly or in combination of two or more. Those containing a saturated alicyclic structure having a crosslinked structure are preferred, and preferred examples thereof include norbornanediol, adamantanediol, and tricyclodecanedimethanol. Examples of commercially available products thereof include adamantanetriol (manufactured by Idemitsu Kosan Co., Ltd., manufactured by Mitsubishi Gas Chemical Co., Inc.) and TCD Alcohol DM (manufactured by OXEA GmbH).

Examples of the unsaturated cyclic hydrocarbon structure include cycloalkene skeletons such as a cyclopentene skeleton, a cyclohexene skeleton, a cycloheptene skeleton, and a [4n] annulene skeleton, conjugated ring structures such as a benzene skeleton, a naphthalene skeleton, an anthracene skeleton, an azulene skeleton, and a [4n+2] annulene skeleton, and unsaturated alicyclic structures each having a crosslinked structure such as a dicyclopentadiene skeleton; and examples of the polyols (b) each having such a structure include cyclohexenediol, biphenol, bisphenol, naphthalenediol, and dicyclopentadienyl dimethanol. These may be used singly or in combination of two or more. Preferred are bisphenols including bisphenol A, bisphenol B, bisphenol C, bisphenol E, bisphenol F, bisphenol G, and bisphenol Z; and more preferred is bisphenol A.

[Polyisocyanate (c)]

The polyisocyanate (c) used in the present invention is not particularly limited as long as it is a compound containing two or more isocyanato groups or a multimer thereof. Examples of the polyisocyanate (c) include saturated alicyclic diisocyanates such as 1,4-cyclohexane diisocyanate, isophorone diisocyanate, methylenebis(4-cyclohexyl isocyanate), 1,3-bis(isocyanatomethyl)cyclohexane, 1,4-bis(isocyanatomethyl)cyclohexane, and norbornane diisocyanate, aromatic diisocyanates such as 2,4-tolylene diisocyanate, 2,6-tolylene diisocyanate, diphenylmethane-4,4′-diisocyanate, 1,3-xylylene diisocyanate, and 1,4-xylylene diisocyanate, and aliphatic diisocyanates such as hexamethylene diisocyanate, 2,4,4-trimethylhexamethylene diisocyanate, and 2,2,4-trimethylhexamethylene diisocyanate, and allophanatized multimers, isocyanurated products, and biuret-modified products thereof. These may be used singly or in combination of two or more. Preferred are saturated alicyclic diisocyanates including 1,4-cyclohexane diisocyanate, isophorone diisocyanate, methylenebis(4-cyclohexyl isocyanate), 1,3-bis(isocyanatomethyl)cyclohexane, 1,4-bis(isocyanatomethyl)cyclohexane, and norbornane diisocyanate; and particularly preferred are isophorone diisocyanate (3-isocyanatomethyl-3,5,5-trimethylcyclohexyl isocyanate) and methylenebis(4-cyclohexyl isocyanate) (another name: dicyclohexylmethane-4,4′-diisocyanate). Examples of commercially available products thereof include Desmodur I, Desmodur W (both manufactured by Beyer AG), IPDI, and H12MDI (both manufactured by Degussa AG).

### [Method for Producing Polyurethane Polyol (A)]

The method for producing a polyurethane polyol (A) used in the present invention includes performing polyaddition reaction of a polyolefin polyol (a1) and/or a polyester polyol (a2), a hydroxylated cyclic hydrocarbon compound (b), and a polyisocyanate (c) in the presence or absence of a known urethanation catalyst such as dibutyltin dilaurate, dioctyltin dilaurate, bismuth tris-2-ethylhexanoate, and zirconium tetra acetylacetonate. The reaction is preferably performed in the presence of a catalyst in terms of reducing reaction time. The catalyst is preferably present because it acts also as a curing accelerator when the polyurethane polyol (A) and the saturated aliphatic and/or saturated alicyclic polyisocyanate (B) are allowed to react with each other and cured. However, if the catalyst is used too much, the physical properties of the adhesive for laminating a metal foil to a resin film may be finally adversely affected. Therefore, the amount of the catalyst used is preferably 0.001 to 1 part by mass, more preferably 0.005 to 0.5 part by mass, and further preferably 0.01 to 0.3 part by mass, based on 100 parts by mass of the total amount of the components (a1), (a2), (b), and (c). In the polyaddition reaction, all of the polyolefin polyol (a1) and/or the polyester polyol (a2), the hydroxylated cyclic hydrocarbon compound (b), and the polyisocyanate (c) may be allowed to react with each other at one time. Alternatively, the polyolefin polyol (a1) and/or the polyester polyol (a2) and the hydroxylated cyclic hydrocarbon compound (b) may be, each separately or in a suitable combination, allowed to react with the polyisocyanate (c), followed by mixing and further allowing all the components to react with each other. Specifically, in the latter method, for example, the hydroxylated cyclic hydrocarbon compound (b) is allowed to react with the polyisocyanate (c) to obtain a polyurethane polyisocyanate, and then the polyolefin polyol (a1) and/or the polyester polyol (a2) is allowed to react with the polyurethane polyisocyanate to obtain the polyurethane polyol (A).

Further, the polyaddition reaction may be performed in a solvent. The solvent to be used is not limited. However, when the same solvent as the solvent (C) to be described below, which can be contained in the adhesive for laminating a metal foil to a resin film of the present invention, is used, a step of solvent distillation or the like can be eliminated, and the adhesive can be produced at a lower cost and with a lower environmental burden.

When the polyurethane polyol (A) is produced, the ratio of the number of isocyanato groups contained in the polyisocyanate (c) to the number of hydroxy groups contained in the components (a1), (a2), and (b) (hereinafter also referred to as “NCO/OH ratio”) is preferably 0.5 to 1.3, more preferably 0.7 to 1.2, and further preferably 0.8 to 1.1. When the NCO/OH ratio is 0.5 or more, the adhesive strength of the adhesive layer obtained from the adhesive for laminating a metal foil to a resin film of the present invention will be hardly reduced even if the adhesive layer contacts an electrolytic solution; and when the NCO/OH ratio is 1.3 or less, the gelation in the production of the polyurethane polyol (A) will not easily occur, and the operability of the adhesive for laminating a metal foil to a resin film of the present invention on coating will be satisfactory. Note that the number of hydroxy groups contained in each polyol component can be determined by known methods such as a titration method according to JIS K 1557-1 or the like and spectroscopy according to JIS K 1557-6 or the like. A method according to JIS K 1557-1 (titration method) was used in Examples to be described below. The number of isocyanato groups contained in each isocyanate component can be determined by known methods such as a titration method according to JIS K 6806 or the like.

When the polyurethane polyol (A) is produced, the amount of the hydroxylated cyclic hydrocarbon compound (b) based on 100 parts by mass of the total amount of the components (a1) and (a2) is preferably 5 to 100 parts by mass, more preferably 10 to 50 parts by mass, and further preferably 10 to 45 parts by mass. When the amount is 5 parts by mass or more, the adhesive strength of the adhesive layer obtained from the adhesive for laminating a metal foil to a resin film of the present invention will be hardly reduced even if the adhesive layer contacts an electrolytic solution; and when the amount is 100 parts by mass or less, the solubility of the polyurethane polyol (A) in a solvent and the operability of the adhesive for laminating a metal foil to a resin film of the present invention on coating will be satisfactory.

<Saturated Aliphatic and/or Saturated Alicyclic Polyisocyanate (B)>

The saturated aliphatic and/or saturated alicyclic polyisocyanate (B) in the present invention (hereinafter also referred to as “polyisocyanate (B)”) is used as a curing agent in the adhesive for laminating a metal foil to a resin film of the present invention, and it is described as distinguished from the aforementioned polyisocyanate (c) described as a raw material in the production of the polyurethane polyol (A).

The saturated aliphatic and/or saturated alicyclic polyisocyanate (B) used in the present invention is not particularly limited as long as it is a compound comprising two or more isocyanato groups or a multimer thereof. Examples thereof include aliphatic diisocyanates such as hexamethylene diisocyanate, 2,4,4-trimethylhexamethylene diisocyanate, and 2,2,4-trimethylhexamethylene diisocyanate, and saturated alicyclic diisocyanates such as 1,4-cyclohexane diisocyanate, isophorone diisocyanate, methylenebis(4-cyclohexyl isocyanate), 1,3-bis(isocyanatomethyl)cyclohexane, 1,4-bis(isocyanatomethyl)cyclohexane, and norbornane diisocyanate, and allophanatized multimers, isocyanurated products, and biuret-modified products thereof. These may be used singly or in combination of two or more. In view of the electrolytic solution resistance of the adhesive layer obtained from the adhesive for laminating a metal foil to a resin film of the present invention, a combination of a saturated aliphatic diisocyanate and a saturated alicyclic diisocyanate and only the saturated alicyclic diisocyanate are more preferred.

The NCO/OH ratio of the polyisocyanate (B) to the polyurethane polyol (A) is preferably 1 to 20, more preferably 1 to 15, and further preferably 1 to 13. When the NCO/OH ratio is 1 or more, the adhesive strength of the adhesive layer obtained from the adhesive for laminating a metal foil to a resin film of the present invention, particularly the adhesive strength of the adhesive layer to the resin film, will be satisfactory; and when the NCO/OH ratio is 20 or less, the adhesive strength of the adhesive layer obtained from the adhesive for laminating a metal foil to a resin film of the present invention will be hardly reduced even if the adhesive layer contacts an electrolytic solution.

### <Solvent (C)>

The adhesive for laminating a metal foil to a resin film of the present invention may also comprise a solvent (C). The solvent (C) is not particularly limited as long as it can dissolve or disperse the polyurethane polyol (A) and the polyisocyanate (B). Examples of the solvent (C) include aromatic organic solvents such as toluene and xylene, alicyclic organic solvents such as cyclohexane, methylcyclohexane, and ethylcyclohexane, aliphatic organic solvents such as n-hexane and n-heptane, ester-based organic solvents such as ethyl acetate, propyl acetate, and butyl acetate, and ketone-based organic solvents such as acetone, methyl ethyl ketone, and methyl butyl ketone. These may be used singly or in combination of two or more.

Among these, especially in view of the solubility of the polyurethane polyol (A), ethyl acetate, propyl acetate, butyl acetate, toluene, methylcyclohexane, and methyl ethyl ketone are preferred, and toluene and methyl ethyl ketone are more preferred.

The content of the solvent (C) is preferably 40 to 95 parts by mass, more preferably 50 to 95 parts by mass, and further preferably 80 to 90 parts by mass, based on 100 parts by mass of the adhesive for laminating a metal foil to a resin film comprising the components (A), (B), and (C). When the content of the solvent (C) is 40 parts by mass or more, the operability of the adhesive for laminating a metal foil to a resin film of the present invention on coating will be satisfactory; and when the content of the solvent (C) is 95 parts by mass or less, the controllability of the thickness of the laminate obtained by coating and curing the adhesive for laminating a metal foil to a resin film of the present invention will be satisfactory.

### <Other Components>

The adhesive for laminating a metal foil to a resin film of the present invention may optionally comprise additives such as a reaction accelerator, a tackifier, and a plasticizer. The reaction accelerator is an additive for accelerating the reaction between the polyurethane polyol (A) and the polyisocyanate (B), and examples thereof include organotin compounds such as dioctyltin dilaurate and dioctyltin diacetate and tertiary amines such as 2,4,6-tris(dimethylaminomethyl)phenol, dimethylaniline, dimethyl-p-toluidine, and N,N-di(β-hydroxyethyl)-p-toluidine. These reaction accelerators may be used singly or in combination.

The tackifier is not particularly limited. Examples thereof include natural tackifiers such as a polyterpene resin and a rosin resin, and petroleum-based tackifiers such as an aliphatic (C5) resin, an aromatic (C9) resin, a copolymer (C5/C9) resin, and an alicyclic resin obtained from cracked petroleum fractions of naphtha. Further examples include a hydrogenated resin in which a double bond part of these resins is hydrogenated. These tackifiers may be used singly or in combination of two or more. Examples of the plasticizer include, but not particularly limited to, liquid rubbers such as polyisoprene and polybutene, and process oil.

Further, thermoplastic resins and thermoplastic elastomers, such as an acid-modified polyolefin resin, may be contained as long as they do not impair the effect of the present invention. Examples of the thermoplastic resins and the thermoplastic elastomers which can be contained include an ethylene-vinyl acetate copolymer resin, an ethylene-ethyl acrylate copolymer resin, SEBS (styrene-ethylene-butylene-styrene), and SEPS (styrene-ethylene-propylene-styrene).

### (Laminate)

The laminate of the present invention is obtained by joining a metal foil to a resin film through an adhesive layer obtained from the adhesive for laminating a metal foil to a resin film of the present invention (hereinafter may be simply referred to as the “laminating adhesive of the present invention”). Further, as long as the laminate of the present invention contains a layer in which a metal foil is joined to a resin film through an adhesive layer obtained from the laminating adhesive of the present invention, the laminate may contain other layers in which metal foils and/or resin films are joined to each other through the adhesive layer obtained from the laminating adhesive of the present invention. Known methods, such as a heat lamination method and a dry lamination method, can be used as the joining method. The heat lamination method comprises heat melting a laminating adhesive of the present invention comprising no solvent (C) on the surface of a layer to be in contact with an adhesive layer or heat extruding the laminating adhesive together with the layer to be in contact with the adhesive layer, thereby inserting the laminating adhesive between the layers of a laminate to form the adhesive layer. Further, the dry lamination method comprises coating and drying a laminating adhesive of the present invention comprising a solvent (C) on the surface of a layer to be in contact with an adhesive layer, stacking other layers thereon, and sticking them by compression, thereby inserting the laminating adhesive between the layers of a laminate to form the adhesive layer.

The applications of the laminate of the present invention are not particularly limited, and examples of useful applications include packaging applications. Examples of the contents to be packaged with the laminate include a liquid material containing an acid, an alkali, an organic solvent, or the like, including a solvent-based material such as a putty (such as a putty for thick coating and a putty for thin coating), a coating material (such as oil paint), lacquer (such as clear lacquer), and a compound for motor vehicles. Further, since the laminate is suitable also for packaging the electrolytic solution of a lithium ion battery, it can be used as a packaging material for a battery casing, which is preferred. When the laminate is used as a packaging material for a battery casing, the metal foil is preferably aluminum foil; the resin film preferably comprises a heat-fusible resin film; and an outer layer comprising a heat resistant resin film is preferably provided outside the aluminum foil.

### (Packaging Material for Battery Casing)

The packaging material for a battery casing of the present invention is a packaging material in which an outer layer comprising a heat resistant resin film is provided outside the metal foil of the laminate of the present invention. Further, in order to improve the characteristics such as mechanical strength and electrolytic solution resistance as needed, the packaging material may have a constitution in which a first intermediate resin layer or/and a second intermediate resin layer are added. In a preferred form, the packaging material may specifically have the following constitutions. Note that the adhesive layer means the “adhesive layer obtained from the laminating adhesive of the present invention”, and the metal foil layer is illustrated as the aluminum foil layer.

(1) Outer layer/aluminum foil layer/adhesive layer/resin film layer
(2) Outer layer/first intermediate resin layer/aluminum foil layer/adhesive layer/resin film layer
(3) Outer layer/aluminum foil layer/second intermediate resin layer/adhesive layer/resin film layer
(4) Outer layer/first intermediate resin layer/aluminum foil layer/second intermediate resin layer/adhesive layer/resin film layer
(5) Coating layer/outer layer/aluminum foil layer/adhesive layer/resin film layer
(6) Coating layer/outer layer/first intermediate resin layer/aluminum foil layer/adhesive layer/resin film layer
(7) Coating layer/outer layer/aluminum foil layer/second intermediate resin layer/adhesive layer/resin film layer
(8) Coating layer/outer layer/first intermediate resin layer/aluminum foil layer/second intermediate resin layer/adhesive layer/resin film layer

In the above constitutions, a polyamide resin, a polyester resin, a polyethylene resin, or the like is used as the first intermediate resin layer, for the purpose of improving the mechanical strength of a packaging material for a battery casing. A heat adhesive extruded resin, such as a polyamide resin, a polyester resin, a polyethylene resin, and polypropylene, is used as the second intermediate resin layer similar to the first intermediate resin layer, mainly for the purpose of improving electrolytic solution resistance. A single-layer resin film and a multi-layer resin film (produced by two-layer co-extrusion, three-layer co-extrusion, or the like) can be used as the resin film layer. Further, the single-layer resin film and the multi-layer co-extruded resin film can also be used as the second intermediate resin layer. The thickness of the first intermediate resin layer and the second intermediate resin layer is, but not particularly limited to, normally about 0.1 to 30 μm when these layers are provided.

### (Heat Resistant Resin Film for Outer Layer)

The resin film used for the outer layer needs to be excellent in heat resistance, formability, insulation properties, and the like, and a stretched film of a polyamide (nylon) resin or a polyester resin is generally used. The thickness of the outer layer film is about 9 to 50 μm. When the thickness is less than 9 μm, the elongation of the stretched film will be poor when a packaging material is formed, which may lead to the occurrence of necking in the aluminum foil to easily result in poor forming. On the other hand, when the thickness is more than 50 μm, the effect of formability is not necessarily improved, and conversely, the volume energy density is reduced, leading only to cost increase. The thickness of the outer layer film is more preferably about 10 to 40 μm, further preferably 20 to 30 μm.

It is preferred to use the following film as a film used for the outer layer, in terms of obtaining a sharper shape: the film has a tensile strength of 150 N/mm² or more, preferably 200 N/mm² or more, and further preferably 250 N/mm² or more and a tensile elongation in three directions of 80% or more, preferably 100% or more, and further preferably 120% or more, when the film is cut to a predetermined size so that each of the three directions of 0°, 45°, and 90° may be the direction of tensileness and then subjected to a tensile test, where the direction of stretch of the stretched film is 0°. The above effect is sufficiently exhibited when the film has a tensile strength of 150 N/mm² or more or has a tensile elongation of 80% or more. Note that the values of the tensile strength and the tensile elongation are values at break in the tensile test of the film (a test piece: 150 mm in length×15 mm in width×9 to 50 μm in thickness, a stress rate: 100 mm/min). The test pieces are cut in each of the three directions.

### (Metal Foil)

A metal foil plays a role of a barrier to water vapor and the like, and pure aluminum or an O material (soft material) of an aluminum-iron alloy is generally used and preferred as the material of the metal foil. The thickness of aluminum foil is preferably about 10 to 100 μm for securing processability and for securing barrier properties of preventing permeation of oxygen and moisture into packaging. If the thickness of aluminum foil is less than 10 μm, the aluminum foil may break during forming or a pinhole may occur, causing permeation of oxygen and moisture. On the other hand, if the thickness of aluminum foil exceeds 100 μm, the improvement effect of breakage during forming and the effect of preventing occurrence of pinhole will not be particularly improved, but only the total thickness of a packaging material will be high, thus increasing mass and reducing volume energy density. Aluminum foil having a thickness of about 30 to 50 μm is generally used, and it is preferred to use aluminum foil having a thickness of 40 to 50 μm. Note that aluminum foil is preferably subjected to chemical conversion treatment, such as undercoat treatment with a silane coupling agent, a titanium coupling agent, and the like and chromate treatment, for improving adhesive properties with a resin film and improving corrosion resistance.

### (Resin Film)

As a resin film, a heat-fusible resin film made of polypropylene, polyethylene, maleic acid-modified polypropylene, an ethylene-acrylate copolymer, an ionomer resin, or the like is preferred. These resins have heat-sealing properties and function for improving the chemical resistance to a highly corrosive electrolytic solution of a lithium secondary battery and the like. The thickness of these films is preferably 9 to 100 μm, more preferably 20 to 80 μm, and most preferably 40 to 80 μm. When the thickness of a resin film is 9 μm or more, sufficient heat sealing strength will be obtained, and the corrosion resistance to an electrolytic solution and the like will be satisfactory. When the thickness of a resin film is 100 μm or less, a packaging material for a battery casing will have a sufficient strength and good formability.

### (Coating Layer)

The packaging material for a battery casing of the present invention may be provided with a coating layer on an outer layer. Examples of the method of forming a coating layer include a method involving coating the outer layer with a polymer having gas barrier properties and a method involving vapor-depositing aluminum metal or an inorganic oxide such as silicon oxide and aluminum oxide to coat the outer layer with a thin film of the metal or the inorganic substance. A laminate having better barrier properties against water vapor and other gases can be obtained by providing a coating layer.

### (Battery Case)

The battery case of the present invention is formed of the packaging material for a battery casing of the present invention. The packaging material for a battery casing of the present invention is excellent in electrolytic solution resistance, heat resistance, and barrier properties against water vapor and other gases, and is suitably used as a battery case for a secondary battery, particularly for a lithium ion battery. Further, since the packaging material for a battery casing of the present invention has very good formability, the battery case of the present invention can be simply obtained by forming according to a known method. The method of forming is not particularly limited, but when the packaging material is formed by deep drawing or stretch forming, a battery case having a highly complicated shape and a high dimensional accuracy can be produced.

### EXAMPLES

Hereinafter, the present invention will be more specifically described with reference to Examples and Comparative Examples, but the present invention is not limited to these Examples at all.

### Synthesis Example 1

To a reaction vessel equipped with a stirrer and a water separator, were charged 220.00 g of “Sovermol 908” (manufactured by BASF AG) as a hydrogenated dimer diol, 230.00 g of “EMPOL 1008” (manufactured by BASF AG) as a hydrogenated dimer acid, and 0.10 g of dibutyltin dilaurate “KS-1260” (manufactured by Sakai Chemical Industry Co., Ltd.) as a catalyst. The mixture was subjected to dehydration esterification reaction at about 240° C. The pressure at the start of the reaction was normal pressure, and the pressure was then reduced while allowing condensed water to flow out, thus obtaining polyester polyol (hereinafter described as polyester polyol (1)).

### Synthesis Example 2

To a reaction vessel equipped with a stirrer, a thermometer, and a condenser, were charged 23.29 g of bisphenol A (compound name: 2,2-bis(4-hydroxyphenyl)propane, manufactured by Nippon Steel Chemical Co., Ltd.), 0.01 g of “KS-1260” (dibutyltin dilaurate, manufactured by Sakai Chemical Industry Co., Ltd.), 34.02 g of “Desmodur I” (isophorone diisocyanate manufactured by Beyer AG), and 113.13 g of methyl ethyl ketone. The mixture was heated to 85 to 90° C. using an oil bath with stirring. Then, the reaction was continued for 2.5 hours with stirring, thus obtaining a solution of polyurethane polyisocyanate (hereinafter described as polyurethane polyisocyanate (2)) in methyl ethyl ketone.

### Synthesis Example 3

A solution of polyurethane polyisocyanate (hereinafter described as polyurethane polyisocyanate (3)) in methyl ethyl ketone was obtained in the same manner as in Synthesis Example 2 except that 20 g of bisphenol F (manufactured by Honshu Chemical Industry Co., Ltd.) was used instead of bisphenol A.

### Synthesis Example 4

To a reaction vessel equipped with a stirrer, a thermometer, and a condenser, were charged 112.50 g of polyester polyol (1), 12.50 g of “TCD Alcohol DM” (tricyclodecane dimethanol, manufactured by Oxea Corporation), 0.04 g of hydroquinone monomethyl ether (manufactured by Wako Pure Chemical Industries, Ltd.), 0.03 g of “KS-1260” (dibutyltin dilaurate, manufactured by Sakai Chemical Industry Co., Ltd.), 28.97 g of “Desmodur W” (methylenebis(4-cyclohexylisocyanate, manufactured by Beyer AG), and 70 g of toluene. The mixture was heated to 85 to 90° C. using an oil bath with stirring. Then, the reaction was continued for 2.5 hours with stirring. Then, an infrared absorption spectrum was measured, and the reaction was completed when it was verified that absorption of an isocyanato group had disappeared. Further, thereto was added 636.5 g of toluene followed by stirring to dissolve the reaction product, thus obtaining a solution of polyurethane polyol (hereinafter described as polyurethane polyol (4)) in toluene (solid concentration: 18% by mass).

### Synthesis Examples 5-10, Comparative Synthesis Examples 11-13

The synthesis was performed in the same manner as in Synthesis Example 3 using the components and the amounts as shown in Table 2 to obtain solutions of polyurethane polyols (4)-(13) in toluene or a mixed solvent of toluene and methyl ethyl ketone (solid concentration: 18% by mass).

In Table 2, GI-1000 and GI-2000 represent hydrogenated polybutadiene polyols manufactured by Nippon Soda Co., Ltd.; G-1000 represents polybutadiene polyol manufactured by Nippon Soda Co., Ltd.; and 14BG represents 1,4-butanediol manufactured by Mitsubishi Chemical Corporation.

The data for Synthesis Examples 1-10 and Comparative Synthesis Examples 11-13 are shown in Tables 1 and 2.

### Example 1

To 33.33 g of a solution of polyurethane polyol (4) in toluene (6.00 g of solids and 27.33 g of toluene) obtained in Synthesis Example 4, were added 0.34 g of “Duranate TKA-100” (isocyanurat of hexamethylene diisocyanate, manufactured by Asahi Kasei Chemicals Corporation) and 15.08 g of toluene to prepare an adhesive 1 for laminating a metal foil to a resin film. Next, a packaging material for a battery casing having a structure of outer layer/adhesive for outer layer/aluminum foil layer/laminating adhesive 1/resin film was produced as follows by a dry lamination method using the laminating adhesive 1.

Outer layer: Stretched polyamide film (25 μm in thickness)

Adhesive for outer layer: Urethane adhesive for dry lamination (manufactured by Toyo-Morton, Ltd.: AD502/CAT10, coating amount: 3 g/m² (in coating))

Aluminum foil layer: Aluminum foil of aluminum-iron alloy (AA standard 8079-O material, thickness: 40 μm)

Laminating adhesive 1: The adhesive 1 for laminating a metal foil to a resin film (coating amount: thickness after drying being 2 μm)

Resin film: Non-stretched polypropylene film (thickness: 30 μm)

### Examples 2-7, Comparative Examples 1-5

Adhesives 2-12 for laminating a metal foil to a resin film were prepared in the same manner as in Example 1 using the components and the amounts as shown in Table 3, and a packaging material for a battery casing was produced using each adhesive for laminating a metal foil to a resin film.

In Table 3, the acid-modified polypropylene is an acid-modified polypropylene (acid value: 20 mg/KOH) modified with maleic anhydride and octyl acrylate, and Millionate MR-200 represents polymeric diphenylmethane diisocyanate manufactured by Nippon Polyurethane Industry Co., Ltd.

### <Peel Strength>

The resulting packaging materials for battery cases were measured for T-peel strength in a normal state, T-peel strength after immersing in an electrolytic solution solvent, and T-peel strength in 85° C. atmosphere. The conditions and methods of measurement are as described in the following (1)-(3). Each test was performed by n=2, and the average value was taken. Further, the results are shown in Table 4 (the unit is all N/15 mm).

### (1) T-Peel Strength in Normal State

A test piece having 150 mm in length×15 mm in width and Autograph AG-X (manufactured by Shimadzu Corporation) were used. The test piece was peeled at a peel rate of 100 mm/min in an atmosphere of 23° C.×50% RH to measure the 180° peel strength between an aluminum foil layer and a non-stretched polypropylene film layer.

(2) T-Peel Strength after Immersing in Electrolytic Solution Solvent

A test piece having 150 mm in length×15 mm in width is immersed in an electrolytic solution solvent (ethylene carbonate/diethyl carbonate, mass ratio: 50/50) and allowed to stand in 85° C. atmosphere for one day. Then, the test piece is taken out of the solvent and used to measure the 180° peel strength between an aluminum foil layer and a non-stretched polypropylene film layer in the same manner as in the above (1).

### (3) T-Peel Strength in 85° C. Atmosphere

A test piece having 150 mm in length×15 mm in width and Autograph AG-X (manufactured by Shimadzu Corporation) were used. The test piece is allowed to stand in 85° C. atmosphere to allow the temperature of the test piece to reach 85° C. and then peeled at a peel rate of 100 mm/min to measure the 180° peel strength between an aluminum foil layer and a non-stretched polypropylene film layer.

TABLE 1

| | | Synthesis | Synthesis |
|---|---|---|---|
| | Synthesis | Example 2 | Example 3 |
| | Example 1 | Polyurethane | Polyurethane |
| | Polyester | polyisocyanate | polyisocyanate |
| Composition (unit: g) | polyol (1) | (2) | (3) |
| Polyol or hydroxylated | | | |
| hydrocarbon | | | |
| Sovermol 908 | 220 | | |
| Bisphenol A | | 23 | |
| Bisphenol F | | | 20 |
| Hydrogenated dimer acid | | | |
| EMPOL 1008 | 230 | | |
| Polyisocyanate | | | |
| Polyisocyanate Desmodur I | | 34 | 34 |
| Catalyst | | | |
| KS-1260 | 0.1 | 0.01 | 0.01 |
| Solvent | | | |
| Methyl ethyl ketone | | 113 | 113 |

TABLE 2

| | | Synthesis | Synthesis | Synthesis | Synthesis | Synthesis | Synthesis |
|---|---|---|---|---|---|---|---|
| | | Example 4 | Example 5 | Example 6 | Example 7 | Example 8 | Example 9 |
| | | Polyurethane | Polyurethane | Polyurethane | Polyurethane | Polyurethane | Polyurethane |
| Composition (unit: g) | | polyol (4) | polyol (5) | polyol (6) | polyol (7) | polyol (8) | polyol (9) |
| Component (a1) | GI-1000 | | 108 | 79 | | 93 | 93 |
| Polyolefin polyol | GI-2000 | | | | 108 | | |
| | G-1000 | | | | | | |
| Component (a2) | Polyester polyol (1) | 113 | | | | | |
| Polyester polyol | | | | | | | |
| Component (b) | TCD Alcohol | 13 | 12 | 34 | 12 | | |
| Alicyclic polyol | DM | | | | | | |
| Chain polyol | 14BG | | | | | | |
| Component (c) | Desmodur W | 29 | 30 | 37 | 25 | | |
| Polyisocyanate | | | | | | | |
| Components | Polyurethane | | | | | 57 | |
| (b) + (c) | polyisocyanate (2) | | | | | | |
| | Polyurethane | | | | | | 54 |
| | polyisocyanate (3) | | | | | | |
| Catalyst | KS-1260 | 0.03 | 0.03 | 0.03 | 0.03 | 0.03 | 0.03 |
| Antioxidant | Hydroquinone | 0.04 | 0.04 | 0.04 | 0.04 | 0.04 | 0.04 |
| | monomethyl | | | | | | |
| | ether | | | | | | |
| Solvent | Toluene | 707 | 684 | 342 | 661 | 571 | 569 |
| | Methyl ethyl | | | 342 | | 113 | 111 |
| | ketone | | | | | | |
| NCO/OH ratio | | 0.9 | 0.9 | 0.9 | 0.9 | 0.9 | 0.9 |

| | | | Comparative | Comparative | Comparative |
|---|---|---|---|---|---|
| | | Synthesis | Synthesis | Synthesis | Synthesis |
| | | Example 10 | Example 11 | Example 12 | Example 13 |
| | | Polyurethane | Polyurethane | Polyurethane | Polyurethane |
| Composition (unit: g) | | polyol (10) | polyol (11) | polyol (12) | polyol (13) |
| Component (a1) | GI-1000 | | 120 | | 108 |
| Polyolefin polyol | GI-2000 | | | | |
| | G-1000 | 108 | | | |
| Component (a2) | Polyester polyol (1) | | | 142 | |
| Polyester polyol | | | | | |
| Component (b) | TCD Alcohol | 12 | | | |
| Alicyclic polyol | DM | | | | |
| Chain polyol | 14BG | | | | 12 |
| Component (c) | Desmodur W | 30 | 17 | 19 | 47 |
| Polyisocyanate | | | | | |
| Components | Polyurethane | | | | |
| (b) + (c) | polyisocyanate (2) | | | | |
| | Polyurethane | | | | |
| | polyisocyanate (3) | | | | |
| Catalyst | KS-1260 | 0.03 | 0.03 | 0.03 | 0.03 |
| Antioxidant | Hydroquinone | 0.04 | 0.04 | 0.04 | 0.04 |
| | monomethyl | | | | |
| | ether | | | | |
| Solvent | Toluene | 684 | 626 | 662 | 381 |
| | Methyl ethyl | | | | 381 |
| | ketone | | | | |
| NCO/OH ratio | | 0.9 | 0.9 | 0.9 | 0.9 |

TABLE 3

| | | Example 1 | Example 2 | Example 3 | Example 4 | Example 5 | Example 6 | Example 7 |
|---|---|---|---|---|---|---|---|---|
| Composition (unit: g) | | Composition 1 | Composition 2 | Composition 3 | Composition 4 | Composition 5 | Composition 6 | Composition 7 |
| Component (A) | Polyurethane | 6 | | | | | | |
| | polyol (4) | | | | | | | |
| | Polyurethane | | 6 | | | | | |
| | polyol (5) | | | | | | | |
| | Polyurethane | | | 6 | | | | |
| | polyol (6) | | | | | | | |
| | Polyurethane | | | | 6 | | | |
| | polyol (7) | | | | | | | |
| | Polyurethane | | | | | 6 | | |
| | polyol (8) | | | | | | | |
| | Polyurethane | | | | | | 6 | |
| | polyol (9) | | | | | | | |
| | Polyurethane | | | | | | | 6 |
| | polyol (10) | | | | | | | |
| | Polyurethane | | | | | | | |
| | polyol (11) | | | | | | | |
| | Polyurethane | | | | | | | |
| | polyol (12) | | | | | | | |
| | Polyurethane | | | | | | | |
| | polyol (13) | | | | | | | |
| Modified | Acid-modified | | | | | | | |
| polyolefin | polypropylene | | | | | | | |
| Component (B) | Duranate | 0.34 | 0.22 | 0.37 | 0.17 | 0.27 | 0.22 | 0.22 |
| Polyisocyanate | TKA-100 | | | | | | | |
| | Millionate | | | | | | | |
| | MR-200 | | | | | | | |
| Component (C) | Toluene | 42 | 42 | 21 | 41 | 21 | 42 | 42 |
| Solvent | Methyl ethyl | | | 21 | | 21 | | |
| | ketone | | | | | | | |

| | | Comparative | Compa ative | Comparative | Comparative | Comparative |
|---|---|---|---|---|---|---|
| | | Example 1 | Example 2 | Example 3 | Example 4 | Example 5 |
| Composition (unit: g) | | Composition 8 | Composition 9 | Composition 10 | Composition 11 | Composition 12 |
| Component (A) | Polyurethane | | | | | |
| | polyol (4) | | | | | |
| | Polyurethane | | | | | |
| | polyol (5) | | | | | |
| | Polyurethane | | | | | |
| | polyol (6) | | | | | |
| | Polyurethane | | | | | |
| | polyol (7) | | | | | |
| | Polyurethane | | | | | |
| | polyol (8) | | | | | |
| | Polyurethane | | | | | |
| | polyol (9) | | | | | |
| | Polyurethane | | | | | |
| | polyol (10) | | | | | |
| | Polyurethane | 6 | | | | |
| | polyol (11) | | | | | |
| | Polyurethane | | 6 | 6 | | |
| | polyol (12) | | | | | |
| | Polyurethane | | | | 6 | |
| | polyol (13) | | | | | |
| Modified | Acid-modified | | | | | 6 |
| polyolefin | polypropylene | | | | | |
| Component (B) | Duranate | 0.16 | 0.21 | | 0.37 | 0.48 |
| Polyisocyanate | TKA-100 | | | | | |
| | Millionate | | | 0.75 | | |
| | MR-200 | | | | | |
| Component (C) | Toluene | 41 | 42 | 42 | 21 | 56 |
| Solvent | Methyl ethyl | | | | 21 | |
| | ketone | | | | | |

TABLE 4

| | Example | | | | | | |
|---|---|---|---|---|---|---|---|
| | Example 1 | Example 2 | Example 3 | Example 4 | Example 5 | Example 6 | Example 7 |
| Name of | Composition 1 | Composition 2 | Composition 3 | Composition 4 | Composition 5 | Composition 6 | Composition 7 |
| adhesive | | | | | | | |
| composition | | | | | | | |
| T-peel | 13.7 | 13.8 | 10.5 | 13.5 | 13.2 | 13.0 | 13.5 |
| strength in | | | | | | | |
| normal state | | | | | | | |
| T-peel | 8.0 | 9.8 | 12.4 | 9.1 | 10.1 | 8.2 | 8.0 |
| strength after | | | | | | | |
| immersing in | | | | | | | |
| electrolytic | | | | | | | |
| solution | | | | | | | |
| solvent | | | | | | | |
| T-peel | 3.2 | 3.2 | 5.1 | 3.5 | 5.8 | 5.1 | 3.2 |
| strength in | | | | | | | |
| 85° C. | | | | | | | |
| atmosphere | | | | | | | |

| | Example | | | | |
|---|---|---|---|---|---|
| | Comparative | Compar ative | Comparative | Comparative | Comparative |
| | Example 1 | Example 2 | Example 3 | Example 4 | Example 5 |
| Name of | Composition 8 | Composition 9 | Composition 10 | Composition 11 | Composition 12 |
| adhesive | | | | | |
| composition | | | | | |
| T-peel | 7.4 | 8.8 | 1.5 | 10.4 | 14.3 |
| strength in | | | | | |
| normal state | | | | | |
| T-peel | 4.2 | 7.8 | 1.4 | 2.1 | 11.1 |
| strength after | | | | | |
| immersing in | | | | | |
| electrolytic | | | | | |
| solution | | | | | |
| solvent | | | | | |
| T-peel | 2.0 | 2.8 | 0.0 | 3.0 | 2.6 |
| strength in | | | | | |
| 85° C. | | | | | |
| atmosphere | | | | | |

(Unit: N/15 mm)

The results in Table 4 show that the adhesives for laminating a metal foil to a resin film of the present invention (Examples 1-7) are excellent in all of the T-peel strength in a normal state, the T-peel strength after immersing in an electrolytic solution solvent, and the T-peel strength in 85° C. atmosphere.

On the other hand, the results in Table 4 show that, in the case of using the adhesives for laminating a metal foil to a resin film which do not contain component (b) as a raw material of polyurethane polyol (Comparative Examples 1-4), these adhesives are insufficient in all of the T-peel strength in a normal state, the T-peel strength after immersing in an electrolytic solution solvent, and the T-peel strength in 85° C. atmosphere; and in the case of using the adhesive for laminating a metal foil to a resin film in which a modified polyolefin is used as a base resin (Comparative Example 5), the adhesive is insufficient in the T-peel strength in 85° C. atmosphere.

### INDUSTRIAL APPLICABILITY

The adhesive for laminating a metal foil to a resin film of the present invention has an excellent adhesive strength after immersing in an electrolytic solution and at high temperatures, and is particularly suitable for joining aluminum foil to a heat-fusible resin film. Further, since the laminate of the present invention is excellent in heat resistance and electrolytic solution resistance, it is suitably used for a packaging material for a battery casing used in the preparation of secondary batteries such as lithium ion batteries; and the laminate can be formed to thereby produce a battery case excellent in heat resistance and electrolytic solution resistance. Thus, the production of a safe secondary battery having a long life is achieved by using the battery case.

1. A polyurethane polyol used for a polyurethane adhesive,
the polyurethane polyol being obtained by polyaddition of components comprising a chain polyolefin polyol (a1) and/or a polyester polyol (a2) having a constituent unit derived from a hydrogenated dimer acid and a constituent unit derived from a hydrogenated dimer diol, a hydroxylated hydrocarbon compound (b) having a saturated or unsaturated cyclic hydrocarbon structure and two or more hydroxy groups, and a polyisocyanate (c).

2. An adhesive for laminating a metal foil to a resin film, the adhesive comprising: a polyurethane polyol (A); and a saturated aliphatic and/or saturated alicyclic polyisocyanate (B),
wherein the polyurethane polyol (A) is obtained by polyaddition of components comprising a chain polyolefin polyol (a1) and/or a polyester polyol (a2) having a constituent unit derived from a hydrogenated dimer acid and a constituent unit derived from a hydrogenated dimer diol, a hydroxylated hydrocarbon compound (b) having a saturated or unsaturated cyclic hydrocarbon structure and two or more hydroxy groups, and a polyisocyanate (c).

3. The adhesive for laminating a metal foil to a resin film according to claim 2, wherein the hydroxylated hydrocarbon compound (b) is a polyol containing a saturated alicyclic structure having a crosslinked structure.

4. The adhesive for laminating a metal foil to a resin film according to claim 2, wherein the hydroxylated hydrocarbon compound (b) is a bisphenol compound.

5. The adhesive for laminating a metal foil to a resin film according to claim 2, wherein the polyisocyanate (c) is a saturated alicyclic diisocyanate.

6. The adhesive for laminating a metal foil to a resin film according to claim 2, wherein the chain polyolefin polyol (a1) is a polyolefin polyol which does not substantially contain an unsaturated hydrocarbon structure.

7. The adhesive for laminating a metal foil to a resin film according to claim 2, wherein the amount of the component (b) is 5 to 100 parts by mass based on 100 parts by mass of the total amount of the components (a1) and (a2); and the ratio of the number of isocyanato groups contained in the component (c) to the number of hydroxy groups contained in the components (a1), (a2), and (b) is 0.5 to 1.3.

8. The adhesive for laminating a metal foil to a resin film according to claim 2, wherein the ratio of the number of isocyanato groups contained in the polyisocyanate (B) to the number of hydroxy groups contained in the polyurethane polyol (A) is 1 to 15.

9. The adhesive for laminating a metal foil to a resin film according to claim 2, the adhesive further comprising a solvent (C).

10. A laminate in which a metal foil and a resin film are laminated through an adhesive layer obtained from the adhesive for laminating a metal foil to a resin film according to claim 2.

11. The laminate according to claim 10, wherein the metal foil is aluminum foil, and the resin film comprises a heat-fusible resin film.

12. The laminate according to claim 10, wherein the thickness of the metal foil is 10 to 100 μm, and the thickness of the resin film is 9 to 100 μm.

13. A packaging material for a battery casing obtained by using the laminate according to claim 10.

14. A battery case obtained by using the packaging material for a battery casing according to claim 13.

15. A method for producing a battery case, comprising: deep drawing or stretch forming the packaging material for a battery casing according to claim 13.
